(19) United States
(12) Patent Application Publication
(10) Pub. No.: US 2017/0066051 A1
(43) Pub. Date: Mar. 9, 2017

(54) METHOD AND APPARATUS FOR ADDITIVE MANUFACTURING

(71) Applicant: Arcam AB, Moelndal (SE)

(72) Inventors: Ulf Ackelid, Goeteborg (SE); Calle Hellestam, Goeteborg (SE)

(21) Appl. No.: 15/232,123

(22) Filed: Aug. 9, 2016

Related U.S. Application Data
(60) Provisional application No. 62/214,625, filed on Sep. 4, 2015.

(51) Int. Cl. B22F 3/10; B33Y 50/00; B33Y 30/00; B33Y 70/00; G01N 23/20; B22F 3/105; B23K 15/00; B23K 15/02; G01N 23/225; B33Y 10/00; B33Y 50/02

(52) U.S. Cl. CPC B22F 3/1017; B33Y 10/00; B33Y 50/00; B33Y 30/00; B33Y 70/00; B33Y 50/02; B22F 3/1055; B23K 15/0086; B23K 15/02; G01N 23/2252; G01N 23/20091; B22F 2003/1057; B22F 2998/10

(57) ABSTRACT

A method for non-destructive evaluation of a manufacturing process when forming a three-dimensional article through successive fusion of parts of a metal powder bed, which parts corresponds to successive cross sections of the three-dimensional article, the method comprising the steps of collecting an X-ray signal, created by the electron beam, from at least one position of the first and/or second metal powder layer and/or a melt pool of the first and/or second metal powder layer and/or a fused first and/or second powder layer by an X-ray detector, comparing the X-ray signal with a reference signal, alarming if the generated X-ray signal compared to the reference signal is indicating contamination material of larger amount than a predetermined value and/or a deviation in Atomic % of the powder material larger than a predetermined value.

### CROSS-REFERENCE TO RELATED APPLICATIONS

This application claims priority to and the benefit of U.S. Provisional Patent Application Ser. No. 62/214,625, filed Sep. 4, 2015; the contents of which as are hereby incorporated by reference in their entirety.

### BACKGROUND

Technical Field

The present invention relates to a method and apparatus for in-situ monitoring of an additive manufacturing process.

Related Art

Freeform fabrication or additive manufacturing is a method for forming three-dimensional articles through successive fusion of chosen parts of powder layers applied to a worktable. A method and apparatus according to this technique is disclosed in US 2013/0343947.

Such an apparatus may comprise a work table on which the three-dimensional article is to be formed, a powder dispenser, arranged to lay down a thin layer of powder on the work table for the formation of a powder bed, a ray gun for delivering energy to the powder whereby fusion of the powder takes place, elements for control of the ray given off by the ray gun over the powder bed for the formation of a cross section of the three-dimensional article through fusion of parts of the powder bed, and a controlling computer, in which information is stored concerning consecutive cross sections of the three-dimensional article. A three-dimensional article is formed through consecutive fusions of consecutively formed cross sections of powder layers, successively laid down by the powder dispenser.

In US 2013/0343947 it is provided a method and device for process monitoring during additive manufacturing. In the document the component is detected optically and thermally during the manufacturing process. In this way distortions in a powder layer may be detected as well as monitoring the fusing temperature of the manufacturing process.

A problem with this method is that material quality of the final product may very well be out of specification which may necessitate time consuming and costly post analysis of the manufactured detail.

### BRIEF SUMMARY

An object of the invention is therefore to provide a method for additive manufacturing of three-dimensional articles which at least reduces the post manufacturing analysis of material properties. The abovementioned object is achieved by the features in the method according to the claims provided herein.

In a first aspect of the invention it is provided a method for non-destructive evaluation of a manufacturing process when forming a three-dimensional article through successive fusion of parts of a metal powder bed, which parts corresponds to successive cross sections of the three-dimensional article, the method comprising the steps of: providing a model of the three dimensional article, providing a first metal powder layer on a work table, directing an electron beam over the work table causing the first metal powder layer to fuse in selected locations according to the model to form a first cross section of the three-dimensional article, providing a second metal powder layer on the work table, directing the electron beam over the work table causing the second metal powder layer to fuse in selected locations according to the model to form a second cross section of the three-dimensional article, wherein the second layer is bonded to the first layer, collecting an X-ray signal, created by the electron beam, from at least one position of the first and/or second metal powder layer and/or a melt pool of the first and/or second metal powder layer and/or a fused first and/or second powder layer by an X-ray detector, comparing the X-ray signal with a reference signal, alarming if the generated X-ray signal compared to the reference signal is indicating contamination material of larger amount than a predetermined value and/or a deviation in Atomic % of the powder material larger than a predetermined value.

An exemplary and non-limiting advantage of this method is that the material can be monitored at any stage of the additive manufacturing process for validating the material chemical composition of the final product. Another advantage is that the detection system can be provided outside the additive manufacturing chamber.

In various example embodiments of the present invention the X-ray signal is an energy dispersive x-ray spectroscopy (EDS) signal and/or wavelength dispersive x-ray spectroscopy (WDS) signal or an accumulated x-ray signal. The advantage of EDS is that it is a relatively quick measuring method but with a relatively low spectral resolution. EDS may give direct identification of elements a few μm down into the material. WDS is a relatively slow technique but with a relatively high spectral resolution. WDS may give direct identification of elements a few μm down into the material. Accumulated X-ray signal may give information about the mean atomic number within the analysis volume.

In various example embodiments of the present invention the x-ray signal may be generated for each layer. By analysing each layer of the three-dimensional article to be built may give an indication that the final product's chemical composition is within or outside a predetermined material specification.

In various example embodiments of the present invention the three-dimensional production will be stopped if the x-ray signal compared to the reference signal is indicating contamination material of larger amount than a predetermined value and/or a deviation in Atomic % of the powder material larger than a predetermined value.

An exemplary and non-limiting advantage of at least this embodiment is that as little material is wasted as necessary if the material specification is detected to be outside a predetermined specification.

In various example embodiments of the present invention further comprising the step of creating a log comprising information about material composition information for at least one position in each cross section of the three-dimensional article.

An exemplary and non-limiting advantage of at least this embodiment is that material verification is made and saved during the manufacturing of the three dimensional article. This is time efficient compared to prior art solutions.

In various example embodiments of the present invention further comprising the steps of: interrupting the fusion of the metal powder for forming the three-dimensional article, moving the electron beam a predetermined distance to at least one measuring position, collecting X-ray measurement data at the at least one measuring position, continuing the fusion of the metal powder for forming the three-dimensional article.

An exemplary and non-limiting advantage of at least this embodiment is that by multiplexing a single electron beam between a melting mode and an measuring mode, material properties can be measured during the solidification phase while manufacturing the 3-dimensional article.

In various example embodiments of the present invention the at least one measuring position is located at an already fused area. An advantage of this embodiment is that it gives information about the actual component built.

In various example embodiments of the present invention the measuring mode comprises an electron beam with predetermined beam scanning speed, beam spot size and beam current. An advantage of this embodiment is that the in measuring mode the beam characteristics are fixed and predetermined, whereas in the melting mode the beam characteristics are typically varied.

In another aspect of the present invention it is provided an apparatus for non-destructive evaluation of a manufacturing process when forming a three-dimensional article through successive fusion of parts of a metal powder bed, which parts corresponds to successive cross sections of the three-dimensional article, the apparatus comprising: a model of the three dimensional article, an arrangement for providing at least a first metal powder layer on a work table, an electron beam source capable for being scanned over the work table causing the first metal powder layer to fuse in selected locations according to the model to form a first cross section of the three-dimensional article, an X-ray detector capable of detecting an x-ray signal created by the electron beam source from at least one position of the powder layer and/or a melt pool of the powder layer and/or a fused powder layer, a comparing unit capable of comparing the X-ray signal with a reference signal, an alarming unit capable of alarming if the generated X-ray signal compared to the reference signal is indicating contamination material of larger amount than a predetermined value and/or a deviation in Atomic % of the powder material larger than a predetermined value.

### BRIEF DESCRIPTION OF THE SEVERAL VIEWS OF THE DRAWING(S)

The invention will be further described in the following, in a non-limiting way with reference to the accompanying drawings. Same characters of reference are employed to indicate corresponding similar parts throughout the several figures of the drawings:

FIG. 1 depicts an apparatus according to an embodiment of the present invention.

FIG. 2 depicts a flow chart of the method according to a first example embodiment of the present invention.

FIG. 3 depicts a flow chart of the method according to a second example embodiment of the present invention.

FIG. 4 is a block diagram of an exemplary system according to various embodiments of the present invention.

FIG. 5A is a schematic block diagram of a server according to various embodiments of the present invention.

FIG. 5B is a schematic block diagram of an exemplary mobile device according to various embodiments of the present invention.

### DETAILED DESCRIPTION OF VARIOUS EMBODIMENTS

To facilitate the understanding of this invention, a number of terms are defined below. Terms defined herein have meanings as commonly understood by a person of ordinary skill in the areas relevant to the present invention.

Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g. of structural material or materials) that are intended to be used for a particular purpose. Such structures, etc. may, for example, be designed with the aid of a three-dimensional CAD system.

The term “electron beam” as used herein in various embodiments refers to any charged particle beam. The source of a charged particle beam can include an electron gun, a linear accelerator and so on.

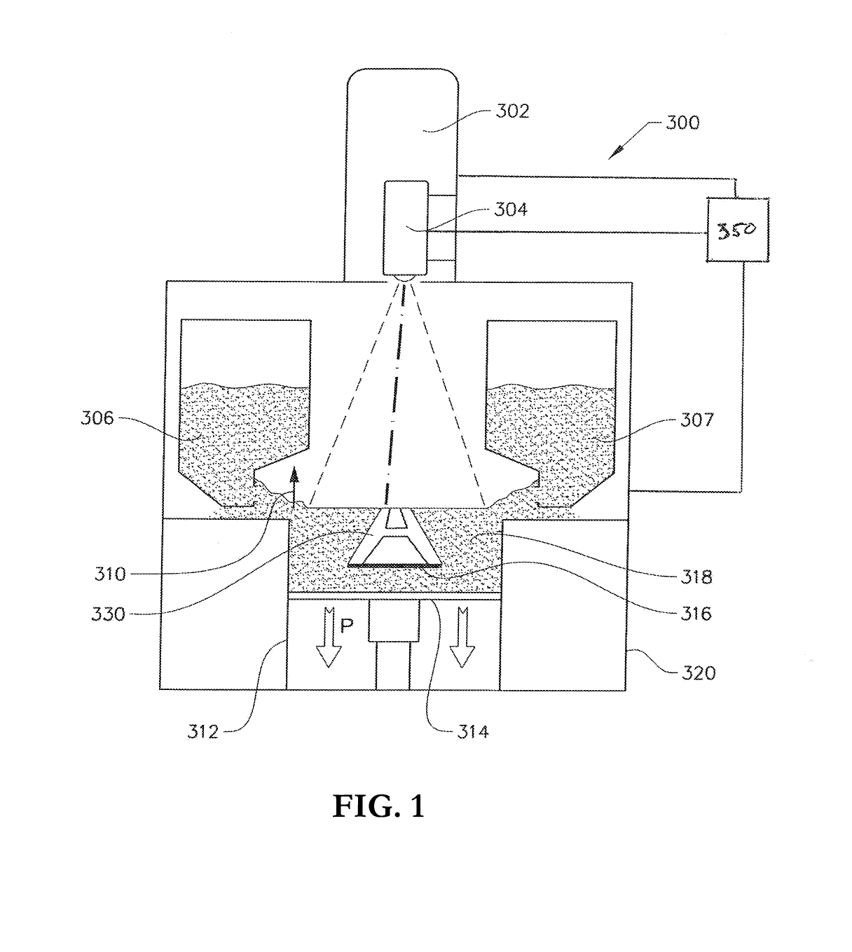

FIG. 1 depicts an embodiment of a freeform fabrication or additive manufacturing apparatus 300 according to of the present invention. The apparatus 300 comprising an electron gun 302; an X-ray detector 304; two powder hoppers 306, 307; a start plate 316; a build tank 312; a powder distributor 310; a build platform 314; a control unit 350 and a vacuum chamber 320.

The vacuum chamber 320 is capable of maintaining a vacuum environment by means of or via a vacuum system, which system may comprise a turbomolecular pump, a scroll pump, an ion pump and one or more valves which are well known to a skilled person in the art and therefore need no further explanation in this context. The vacuum system is controlled by the control unit 350.

The electron gun 302 is generating an electron beam which is used for melting or fusing together powder material 318 provided on the start plate 316. The electron beam from the electron gun also creates x-rays when impinging onto the metal powder before, during or after the powder is fused.

The control unit 350 may be used for controlling and managing the electron beam emitted from the electron beam gun 302. At least one focusing coil (not shown), at least one deflection coil (not shown)and an electron beam power supply (not shown) may be electrically connected to the control unit 350. In an example embodiment of the invention the electron gun 302 generates a focusable electron beam with an accelerating voltage of about 60 kV and with a beam power in the range of 0-10 kW. The pressure in the vacuum chamber may be in the range of 1×10-2-1×10-6 mBar when building the three-dimensional article by fusing the metal powder layer by layer with the electron beam.

The powder hoppers 306, 307 comprise the powder material to be provided on the start plate 316 in the build tank 312. The powder material may for instance be pure metals or metal alloys such as titanium, titanium alloys, aluminum, aluminum alloys, stainless steel, Co—Cr—Mo alloy, etc.

The powder distributor 310 may be arranged to lay down a thin layer of the powder material on the start plate 316. During a work cycle the build platform 314 will be lowered successively in relation to the electron gun 302 after each added layer of metal powder material. In order to make this movement possible, the build platform 314 is in one embodiment of the invention arranged movably in vertical direction, i.e., in the direction indicated by arrow P. This means that the build platform 314 starts in an initial position, in which a first powder material layer of necessary thickness has been laid down on the start plate 316. The build platform is thereafter lowered in connection with laying down a new powder material layer for the formation of a new cross section of a three-dimensional article. Means for lowering the build platform 314 may for instance be through a servo engine equipped with a gear, adjusting screws etc.

The X-ray detector is used for detecting x-rays emanating from the powder material and/or the melt pool and/or already fused material. X-ray signals may emanate from at least one position of at least one layer of the three-dimensional article. In an example embodiment x-ray signals from at least one position of each layer of the three-dimensional article is detected by the detector. In still another example embodiment a plurality of positions of each layer of the three-dimensional article is detected by the detector. X-ray signals from the unfused powder may be compared with reference signals for unfused powder of the same material in the comparing unit. In the same comparing unit X-ray signals from the melt pool may be compared with reference signals for the melt pool of the same material and/or X-ray signals from already fused powder may be compared with reference signals for already fused powder of the same material. The comparing unit may be arranged in the control unit 350 or being a separate unit.

If a discrepancy is detected being larger than a predetermined value, an alarming unit may alarm and/or stop the build process. In case of stopping the build process an operator may choose between different options depending on where the discrepancy in detected. Detected discrepancies may be stored throughout the build process in a separate validation file which may be accessible after the manufacturing process is completed. This validation file may be used for conforming that the manufacturing process was made according to predetermined conditions.

Non-sintered powder or non-fused powder may be analyzed with X-ray signals before the fusing process is started to make sure that the powder in each layer is according to predetermined material specifications. By analyzing the non-sintered powder and/or non-fused powder material defects such as humidity content in titanium powder material may be detected before the material is actually melted. If a too large humidity level is detected the additive manufacturing machine may choose between removing the powder layer and apply a new powder layer or apply humidity removal process for the powder material. The humidity removal process may be to heat the powder surface for a certain time at a certain temperature. The fusion process may be initiated as soon as the material properties are fulfilling the predetermined specification.

The melt pool may be analyzed with X-ray signals. By doing this material contaminations may be detected such as material falling down from the additive manufacturing apparatus into the melt pool. When manufacturing details in alloys some alloying elements may have a lower melt temperature than other alloying elements. The elements with the lower melting temperature may be prone to evaporate from the melt pool and attach inside the additive manufacturing apparatus. An example of such an alloy is TiAl where aluminum tends to evaporate from the alloy and attach to the inside of the additive manufacturing machine. Such attached material may later on fall down into the melt pool and change the material characteristics locally. By keeping control of possible material contamination one can determine not only if they have taken place but also where in the final product such contamination may be present. In case of a contamination at a non-critical position the manufacturing may be continued. In case of a contamination at a critical position the manufacturing process may be stopped or further analyzed when the actual powder layer is solidified.

An already fused powder layer, i.e., a solidified layer, may be analyzed with X-ray signals. In the analyze final material compositions may be compared with reference material compositions in order to verify that the final product falls within predetermined material specification. If any discrepancy is detected the manufacturing process may be stopped if located at a critical position. If a material contamination is detected in the melt pool the material characteristic is further compared in the already fused layer in order to see if the final material properties may nevertheless fulfill the predetermined material characteristics. If not fulfilling the material properties a further remelt of the latest layer may be performed. This remelting may cause the contamination material to spread further in the final product so that the material properties may be met.

The control unit may store x-ray characteristics for powder, melt pool and already fused material for a number of different alloys and/or pure elements.

The X-ray signal may be an energy dispersive x-ray spectroscopy (EDS) signal and/or a wavelength dispersive x-ray spectroscopy (WDS) signal and/or an ordinary accumulated x-ray signal.

WDS and EDS gives information about the chemical composition where the EDS technique is quicker and has a lower resolution compared to WDS.

According to the invention, the electron beam which is used for preheating the powder material and/or melting the powder material and/or post heat treating the melted material is also used to excite in the powder material and/or melt pool and/or already fused portion an X-radiation. The X-radiation may enter a spectrographic detector whose output affords spectrographic information on the composition of the powder material. The spectrographic information may be compared to a reference signal in order to determine if the powder material and/or melt pool and/or already fused area has the correct material composition.

The three-dimensional production may be stopped if the x-ray signal compared to the reference signal is indicating contamination material of larger amount than a predetermined value and/or a deviation in Atomic % of the powder material larger than a predetermined value.

A validation log may be created comprising information about material composition information for at least one position in each cross section of the three-dimensional article.

In an example embodiment of a method according to the present invention for non-destructive evaluation of a manufacturing process when forming a three-dimensional article through successive fusion of parts of a metal powder bed, which parts corresponds to successive cross sections of the three-dimensional article comprising a first step 402 of providing a model of the three dimensional article. The model may be generated via a CAD (Computer Aided Design) tool.

In a second step 404 a first metal powder layer is provided on the work table 316. Powder may be distributed evenly over the worktable according to several methods. One way to distribute the powder is to collect material fallen down from the hopper 306, 307 by a rake system. The rake is moved over the build tank thereby distributing the powder over the start plate. The distance between a lower part of the rake and the upper part of the start plate or previous powder layer determines the thickness of powder distributed over the start plate. The powder layer thickness can easily be adjusted by adjusting the height of the build platform 314.

In a third step 406 an electron beam is directed over the work table 316 causing the first metal powder layer to fuse in selected locations to form a first cross section of the three-dimensional article. The electron beam is directed over the work table 316 from instructions given by the control unit 350. In the control unit 350 instructions for how to control the beam gun for each layer of the three-dimensional article is stored, i.e., beam current, beam speed, beam spot size and beam pattern etc.

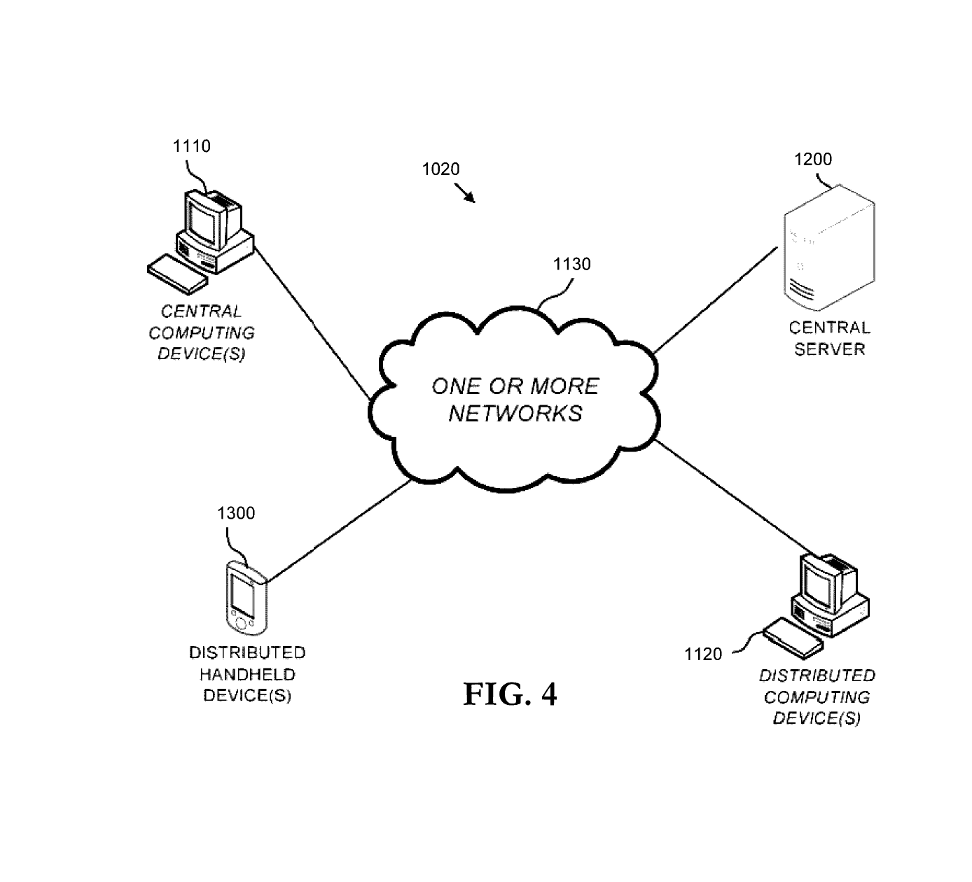

After a first layer is finished, i.e., the fusion of powder material for making a first layer of the three-dimensional article, a second metal powder layer is provided on the work table 316 denoted by step 408 in FIG. 4. The second metal powder layer may be distributed according to the same manner as the previous layer. However, there might be alternative methods in the same additive manufacturing machine for distributing powder onto the work table. For instance, a first layer may be provided by means of or via a first powder distributor, a second layer may be provided by another powder distributor. The design of the powder distributor is automatically changed according to instructions from the control unit 350. A powder distributor in the form of a single rake system, i.e., where one rake is catching powder fallen down from both a left powder hopper 306 and a right powder hopper 307, the rake as such can change design.

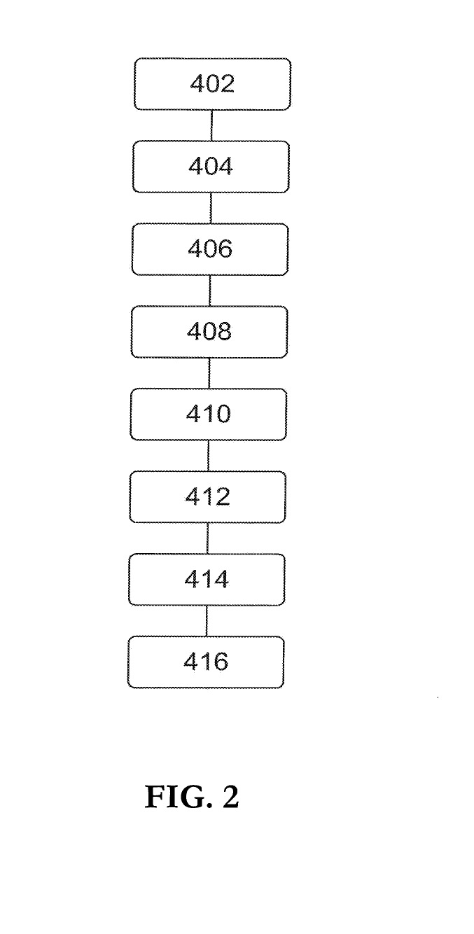

After having distributed the second metal powder layer on the work table 316, the electron beam is directed over the work table causing the second powder layer to fuse in selected locations to form a second cross section of the three-dimensional article denoted by step 410 in FIG. 2. Fused portions in the second layer may be bonded to fused portions of the first layer. The fused portions in the first and second layer may be melted together by melting not only the powder in the uppermost layer but also remelting at least a fraction of a thickness of a layer directly below the uppermost layer.

At least one first X-ray signal may be captured of at least a first portion of an unfused powder layer, a fusion zone of the first powder layer or an already fused portion of the powder layer denoted by step 412 in FIG. 4. The X-rays are generated by the same electron beam impinging onto the powder material pre fusing process, such as preheating, in order to prepare the powder for melting, by the same electron beam which is melting the powder material and the same electron beam which may be used for post processing the already fused material. The X-ray signal may be detected by at least one X-ray detector 304 provided inside or outside the vacuum chamber 320. The X-ray detector 304 may be any type of X-ray detector including but not limited to an energy dispersive X-ray spectroscopy signal (EDS) detector and/or a wavelength dispersive x-ray spectroscopy signal (WDS) detector and/or an ordinary x-ray detector for accumulated x-ray signals.

In an alternative embodiment of the present invention an X-ray measurement of already fused material may take place during the actual fusion process. This may be accomplished by multiplexing the electron beam to move from a melt pool to at least one measuring position. In the measuring position x-ray signals may be sent to at least one X-ray detector. When the measurement is finished the fusion process in continued. This will interrupt the melting process, but only during a very short time which is limited by the electron beam output frequency. With this measurement technique it may be possible so sample material properties during a cooling phase by measuring several points.

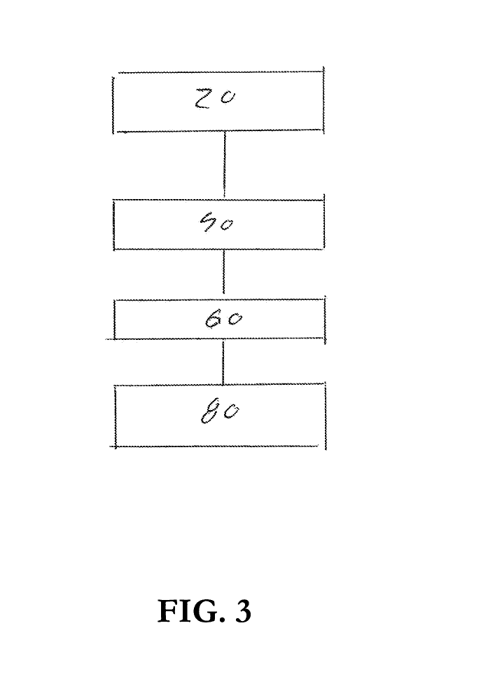

In an example embodiment the fusion of the metal powder for forming the three-dimensional article is interrupted denoted by 20 in FIG. 3. The interruption time may be chosen as short as possible for affecting the fusion process as little as possible. The electron beam is moved a predetermined distance to at least one measuring position denoted by 40 in FIG. 3. The measuring position may be provided at already fused powder or non-fused powder. X-ray measurement data is collected at the at least one measuring position denoted by 60 in FIG. 3. The X-ray data may be collected by one or a plurality of x-ray detectors, which detectors may be of the same type or different types. One may also provide for different types of detectors for measuring different types of signals such as EDS detector, WDS detector, and/or accumulated X-ray detector.

In an example embodiment an electron beam may be moving along a line and thereby may be creating a stable melt pool. During 1 ms the electron beam is moved 1 mm if the scan speed of the electron beam is 1000 mm/s. Having an output frequency being 100 kHz will create 100 output points during 1 ms.

The electron beam then skips back 1 mm and is moving 1 mm during 0.1 ms, i.e., the scan speed is increased to 1000 mm/s. The X-ray response is recorded by at least one X-ray detector during the 0.1 ms. This yields 10 output points spread out on the 1 mm length. The X-ray response data may represent a sample from the melt pool cooling phase.

In another example embodiment the X-ray measurement may be measured an arbitrary long time after the powder material has been fused.

When the electron beam is present on the at least one measuring positions the electron beam is switched into a so called measuring mode. In this mode the electron beam current, the electron beam spot size and the electron beam scanning speed is set to predetermined values. At least one of the electron beam current and/or the electron beam spot size and/or the electron beam scanning speed may be set so a fixed value during the x-ray measurement at the at least one measuring positions. By using a predetermined electron beam signal which is equal each time one is generating X-ray signals at the at least one measuring positons one may eliminate error sources coming from a non-steady electron beam. The X-ray measurement may be made with repeated conditions of the electron beam regardless of the geometry and/or position on the three-dimensional article.

When the measuring is finished after the 0.1 ms the fusion of the metal powder is continued for forming the three-dimensional article denoted by step 80 in FIG. 3. In this embodiment the fusion laterally spaced apart from the measurement, which require the electron beam to be moved from the measuring position back to a melting position. The continued fusion may take place at a melting position which is at least partially overlapping with the latest melting position prior to the measuring started for creating a continuously moving melt pool front. In various example embodiment the continued fusion may take place at a position laterally spaced apart from both the measuring positon and the latest position prior to the measuring started.

The reference signal may be an actual signal from the same material and the same type of layer, i.e., powder, melt pool or already fused powder. The reference signal may also be a simulated signal.

The electron beam not only melts the last applied powder layer but also at least the layer of material below the powder layer resulting in a melt comprising the powder material and already melted material from a previous fusion process.

The thickness of a powder layer may be in the range of 30-150 μm. The size of the metal particles in the powder material may be in the range of 45-150 μm. The powder material may also be in the range of 25-45 μm.

The reference signal may be constructed by means of or via a simulation of the fusion of a given powder layer for forming one layer of a three-dimensional structure. In an example embodiment one may be using a unique reference signal for each layer of the three-dimensional article to be produced. This means that an actual signal of layer n of the three-dimensional article is correlated with a reference signal n and an actual signal of layer n+1 of the three-dimensional article is correlated with a reference signal n+1, where n is an integer going from 1 to the number of layers of the article to be produced. In an alternative example embodiment one is using the same reference signal for all layers or only for layers having equal shape, i.e., if two consecutive layers are equal one can of course use the same reference signal. If two layers only differ to each other in the outer contour, one may have a single reference signal covering the outer shape of the two layers.

The actual detected x-ray signal is compared with the reference signal denoted by step 414. In case of an energy dispersive x-ray spectroscopy signal (EDS) or a wavelength dispersive x-ray spectroscopy signal (WDS) it allows one to identify what particular elements are and their relative proportions (Atomic % for instance) in the powder layer and/or the melt pool and/or the already fused area. By comparing the detected signal with a reference signal one may conclude that the material content and/or the relative proportion is correct.

If the generated X-ray signal compared to the reference signal is indicating contamination material of larger amount than a predetermined value and/or a deviation in Atomic % of the powder material larger than a predetermined value an alarming may take place denoted by step 416. The contamination material may be one or a plurality of the alloying elements in the powder material which is used for manufacturing the three-dimensional article. The contamination material may also be humidity or metal oxide. The contamination may also be surface oxides.

The x-ray signals may be detected for each layer of the three-dimensional article. In an example embodiment a predetermined pattern for each layer of the three-dimensional article is analysed comprising a plurality of detecting positions. The pattern may change from one layer to another since the cross section may alter from one layer to another in a three-dimensional article.

In another aspect of the invention it is provided a program element configured and arranged, when executed on a computer, to implement a method for forming at least one three-dimensional article through successive joining of parts of a material layer. The program element may specifically be configured to perform the steps as outlined in the claim set provided herein.

The program element may be installed in one or more non-transitory computer readable storage mediums. The non-transitory computer readable storage mediums and/or the program element may be associated with the control unit 350 or another control unit. The computer readable storage mediums and the program elements, which may comprise non-transitory computer-readable program code portions embodied therein, may further be contained within one or more non-transitory computer program products. According to various embodiments, the method described elsewhere herein may be computer-implemented, for example in conjunction with one or more processors and/or memory storage areas. Further details regarding these features and configurations are provided, in turn, below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

FIG. 4 is a block diagram of an exemplary system 1020 that can be used in conjunction with various embodiments of the present invention. In at least the illustrated embodiment, the system 1020 may include one or more central computing devices 1110, one or more distributed computing devices 1120, and one or more distributed handheld or mobile devices 1300, all configured in communication with a central server 1200 (or control unit) via one or more networks 1130. While FIG. 4 illustrates the various system entities as separate, standalone entities, the various embodiments are not limited to this particular architecture.

According to various embodiments of the present invention, the one or more networks 1130 may be capable of supporting communication in accordance with any one or more of a number of second-generation (2G), 2.5G, third-generation (3G), and/or fourth-generation (4G) mobile communication protocols, or the like. More particularly, the one or more networks 1130 may be capable of supporting communication in accordance with 2G wireless communication protocols IS-136 (TDMA), GSM, and IS-95 (CDMA). Also, for example, the one or more networks 1130 may be capable of supporting communication in accordance with 2.5G wireless communication protocols GPRS, Enhanced Data GSM Environment (EDGE), or the like. In addition, for example, the one or more networks 1130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 1020 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 1110-1300 are illustrated in FIG. 4 as communicating with one another over the same network 1130, these devices may likewise communicate over multiple, separate networks.

According to one embodiment, in addition to receiving data from the server 1200, the distributed devices 1110, 1120, and/or 1300 may be further configured to collect and transmit data on their own. In various embodiments, the devices 1110, 1120, and/or 1300 may be capable of receiving data via one or more input units or devices, such as a keypad, touchpad, barcode scanner, radio frequency identification (RFID) reader, interface card (e.g., modem, etc.) or receiver. The devices 1110, 1120, and/or 1300 may further be capable of storing data to one or more volatile or non-volatile memory modules, and outputting the data via one or more output units or devices, for example, by displaying data to the user operating the device, or by transmitting data, for example over the one or more networks 1130.

In various embodiments, the server 1200 includes various systems for performing one or more functions in accordance with various embodiments of the present invention, including those more particularly shown and described herein. It should be understood, however, that the server 1200 might include a variety of alternative devices for performing one or more like functions, without departing from the spirit and scope of the present invention. For example, at least a portion of the server 1200, in certain embodiments, may be located on the distributed device(s) 1110, 1120, and/or the handheld or mobile device(s) 1300, as may be desirable for particular applications. As will be described in further detail below, in at least one embodiment, the handheld or mobile device(s) 1300 may contain one or more mobile applications 1330 which may be configured so as to provide a user interface for communication with the server 1200, all as will be likewise described in further detail below.

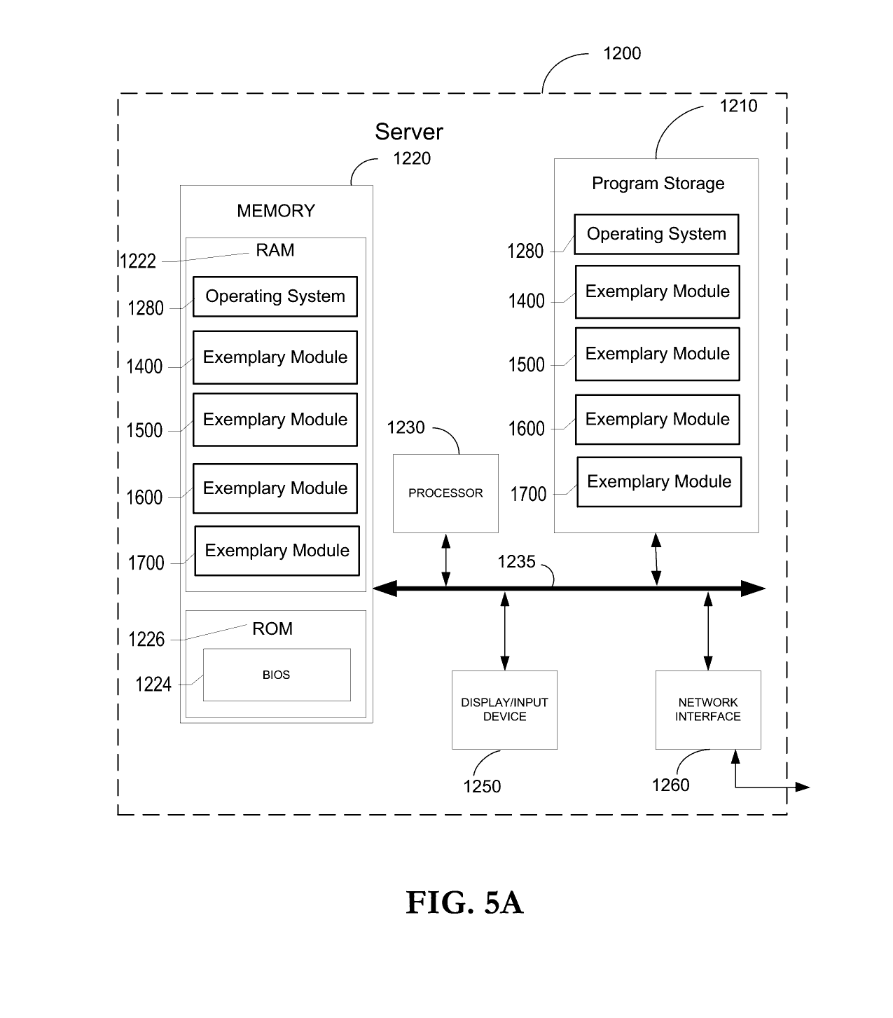

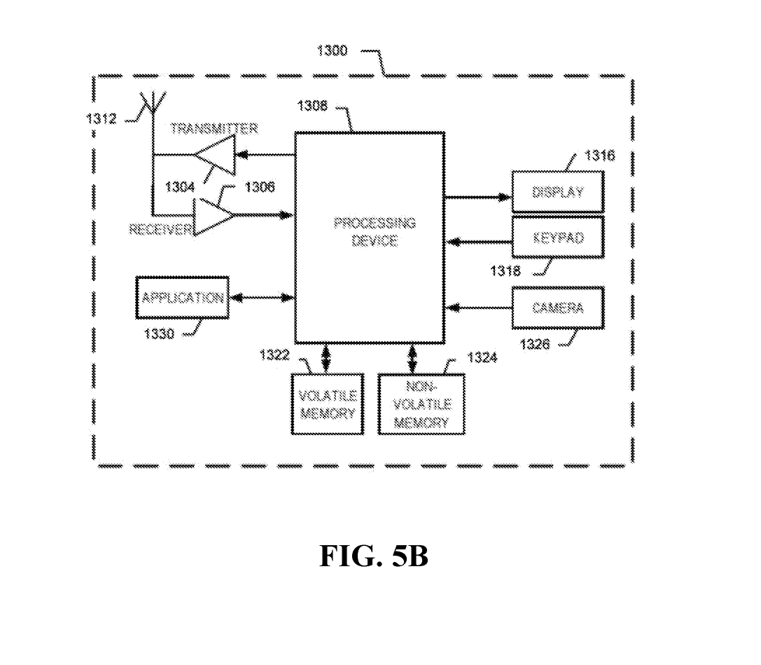

FIG. 5A is a schematic diagram of the server 1200 according to various embodiments. The server 1200 includes a processor 1230 that communicates with other elements within the server via a system interface or bus 1235. Also included in the server 1200 is a display/input device 1250 for receiving and displaying data. This display/input device 1250 may be, for example, a keyboard or pointing device that is used in combination with a monitor. The server 1200 further includes memory 1220, which typically includes both read only memory (ROM) 1226 and random access memory (RAM) 1222. The server's ROM 1226 is used to store a basic input/output system 1224 (BIOS), containing the basic routines that help to transfer information between elements within the server 1200. Various ROM and RAM configurations have been previously described herein.

In addition, the server 1200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 1210 are connected to the system bus 1235 by an appropriate interface. The storage devices 1210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 1210 and/or memory of the server 1200 may further provide the functions of a data storage device, which may store historical and/or current delivery data and delivery conditions that may be accessed by the server 1200. In this regard, the storage device 1210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 1400-1700) comprising, for example, one or more computer-readable program code portions executable by the processor 1230, may be stored by the various storage devices 1210 and within RAM 1222. Such program modules may also include an operating system 1280. In these and other embodiments, the various modules 1400, 1500, 1600, 1700 control certain aspects of the operation of the server 1200 with the assistance of the processor 1230 and operating system 1280. In still other embodiments, it should be understood that one or more additional and/or alternative modules may also be provided, without departing from the scope and nature of the present invention.

In various embodiments, the program modules 1400, 1500, 1600, 1700 are executed by the server 1200 and are configured to generate one or more graphical user interfaces, reports, instructions, and/or notifications/alerts, all accessible and/or transmittable to various users of the system 1020. In certain embodiments, the user interfaces, reports, instructions, and/or notifications/alerts may be accessible via one or more networks 1130, which may include the Internet or other feasible communications network, as previously discussed.

In various embodiments, it should also be understood that one or more of the modules 1400, 1500, 1600, 1700 may be alternatively and/or additionally (e.g., in duplicate) stored locally on one or more of the devices 1110, 1120, and/or 1300 and may be executed by one or more processors of the same. According to various embodiments, the modules 1400, 1500, 1600, 1700 may send data to, receive data from, and utilize data contained in one or more databases, which may be comprised of one or more separate, linked and/or networked databases.

Also located within the server 1200 is a network interface 1260 for interfacing and communicating with other elements of the one or more networks 1130. It will be appreciated by one of ordinary skill in the art that one or more of the server 1200 components may be located geographically remotely from other server components. Furthermore, one or more of the server 1200 components may be combined, and/or additional components performing functions described herein may also be included in the server.

While the foregoing describes a single processor 1230, as one of ordinary skill in the art will recognize, the server 1200 may comprise multiple processors operating in conjunction with one another to perform the functionality described herein. In addition to the memory 1220, the processor 1230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 1200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 1200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 5B provides an illustrative schematic representative of a mobile device 1300 that can be used in conjunction with various embodiments of the present invention. Mobile devices 1300 can be operated by various parties. As shown in FIG. 5B, a mobile device 1300 may include an antenna 1312, a transmitter 1304 (e.g., radio), a receiver 1306 (e.g., radio), and a processing element 1308 that provides signals to and receives signals from the transmitter 1304 and receiver 1306, respectively.

The signals provided to and received from the transmitter 1304 and the receiver 1306, respectively, may include signaling data in accordance with an air interface standard of applicable wireless systems to communicate with various entities, such as the server 1200, the distributed devices 1110, 1120, and/or the like. In this regard, the mobile device 1300 may be capable of operating with one or more air interface standards, communication protocols, modulation types, and access types. More particularly, the mobile device 1300 may operate in accordance with any of a number of wireless communication standards and protocols. In a particular embodiment, the mobile device 1300 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 1300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 1300 can also download changes, add-ons, and updates, for instance, to its firmware, software (e.g., including executable instructions, applications, program modules), and operating system.

According to one embodiment, the mobile device 1300 may include a location determining device and/or functionality. For example, the mobile device 1300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 1300 may also comprise a user interface (that can include a display 1316 coupled to a processing element 1308) and/or a user input interface (coupled to a processing element 308). The user input interface can comprise any of a number of devices allowing the mobile device 1300 to receive data, such as a keypad 1318 (hard or soft), a touch display, voice or motion interfaces, or other input device. In embodiments including a keypad 1318, the keypad can include (or cause display of) the conventional numeric (0-9) and related keys (#, *), and other keys used for operating the mobile device 1300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 1300 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 1300.

The mobile device 1300 may also include one or more of a camera 1326 and a mobile application 1330. The camera 1326 may be configured according to various embodiments as an additional and/or alternative data collection feature, whereby one or more items may be read, stored, and/or transmitted by the mobile device 1300 via the camera. The mobile application 1330 may further provide a feature via which various tasks may be performed with the mobile device 1300. Various configurations may be provided, as may be desirable for one or more users of the mobile device 1300 and the system 1020 as a whole.

It will be appreciated that many variations of the above systems and methods are possible, and that deviation from the above embodiments are possible, but yet within the scope of the claims. Many modifications and other embodiments of the invention set forth herein will come to mind to one skilled in the art to which these inventions pertain having the benefit of the teachings presented in the foregoing descriptions and the associated drawings. Such modifications may, for example, involve using a different source of ray gun than the exemplified electron beam such as laser beam. Other materials than metallic powder may be used, such as powder of polymers and powder of ceramics. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for non-destructive evaluation of a manufacturing process when forming a three-dimensional article through successive fusion of parts of a metal powder bed, which parts corresponds to successive cross sections of the three-dimensional article, the method comprising the steps of:
at least one of providing, referencing, or generating a model of the three dimensional article,
applying a first metal powder layer on a work table,
directing an electron beam over the work table causing the first metal powder layer to fuse in selected locations according to the model to form a first cross section of the three-dimensional article,
applying a second metal powder layer on the work table,
directing the electron beam over the work table causing the second metal powder layer to fuse in selected locations according to the model to form a second cross section of the three-dimensional article, wherein the second layer is bonded to the first layer,
collecting an X-ray signal, created by the electron beam, from at least one position of the first and/or second metal powder layer and/or a melt pool of the first and/or second metal powder layer and/or a fused first and/or second powder layer by an X-ray detector,
comparing the X-ray signal with a reference signal, and
generating an alarm if the generated X-ray signal compared to the reference signal is indicating contamination material of at least one of a greater amount than a predetermined value or a deviation in Atomic % of the powder material larger than a predetermined value.

2. The method according to claim 1, wherein the X-ray signal is at least one of an energy dispersive x-ray spectroscopy (EDS) signal, a wavelength dispersive x-ray spectroscopy (WDS) signal, or an accumulated x-ray signal.

3. The method according to claim 1, wherein the x-ray signal is generated for each layer.

4. The method according to claim 1, wherein the three-dimensional production will be stopped if the x-ray signal compared to the reference signal is indicating contamination material of larger amount than at least one of a predetermined value or a deviation in Atomic % of the powder material larger than a predetermined value.

5. The method according to claim 1, further comprising the step of creating a log comprising information about material composition information for at least one position in each cross section of the three-dimensional article.

6. The method according to claim 1, further comprising the steps of:
interrupting the fusion of the metal powder for forming the three-dimensional article,
moving the electron beam a predetermined distance to at least one measuring position,
collecting X-ray measurement data at the at least one measuring position, and
continuing the fusion of the metal powder for forming the three-dimensional article.

7. The method according to claim 6, wherein the at least one measuring position is located at an already fused area.

8. The method according to claim 6, wherein the electron beam is set in a measuring mode when being at the at least one measuring position.

9. The method according to claim 8, wherein the measuring mode comprises an electron beam with predetermined beam scanning speed, beam spot size and beam current.

10. The method according to claim 1, wherein one or more of the steps of the method are executed via one or more computer processors.

11. An apparatus for non-destructive evaluation of a manufacturing process when forming a three-dimensional article through successive fusion of parts of a metal powder bed, which parts corresponds to successive cross sections of the three-dimensional article, the apparatus comprising:
an arrangement for applying at least a first metal powder layer on a work table based upon a model of the three dimensional article,
an electron beam source configured to be scanned over the work table causing the first metal powder layer to fuse in selected locations according to the model to form a first cross section of the three-dimensional article,
an X-ray detector configured for detecting an x-ray signal created by the electron beam source from at least one position of the powder layer and/or a melt pool of the powder layer and/or a fused powder layer,
a comparing unit configured for comparing the X-ray signal with a reference signal, and
an alarm unit configured for generating an alarm if the generated X-ray signal compared to the reference signal is indicating contamination material of at least one of a larger amount than a predetermined value or a deviation in Atomic % of the powder material larger than a predetermined value.

12. The apparatus according to claim 11, wherein the X-ray signal is an energy dispersive x-ray spectroscopy (EDS) signal and/or wavelength dispersive x-ray spectroscopy (WDS) signal or an accumulated x-ray signal.

13. The apparatus according to claim 11, wherein the x-ray signal is generated for each layer.

14. The apparatus according to claim 11, wherein the apparatus is configured to stop the three-dimensional production if the x-ray signal compared to the reference signal is indicating contamination material of larger amount than a predetermined value and/or a deviation in Atomic % of the powder material larger than a predetermined value.

15. The apparatus according to claim 11, wherein the apparatus is further configured to create a log comprising information about material composition information for at least one position in each cross section of the three-dimensional article.

16. The apparatus according to claim 11, wherein the apparatus is further configured for:
interrupting the fusion of the metal powder for forming the three-dimensional article,
moving the electron beam a predetermined distance to at least one measuring position,
collecting X-ray measurement data at the at least one measuring position, and
continuing the fusion of the metal powder for forming the three-dimensional article.

17. A program element configured and arranged when executed on a computer to implement a method for non-destructive evaluation of a manufacturing process when forming a three-dimensional article through successive fusion of parts of a metal powder bed, which parts corresponds to successive cross sections of the three-dimensional article, the method comprising the steps of:
at least one of providing, referencing, or generating a model of the three dimensional article,
applying a first metal powder layer on a work table,
directing an electron beam over the work table causing the first metal powder layer to fuse in selected locations according to the model to form a first cross section of the three-dimensional article,
applying a second metal powder layer on the work table,
directing the electron beam over the work table causing the second metal powder layer to fuse in selected locations according to the model to form a second cross section of the three-dimensional article, wherein the second layer is bonded to the first layer,
collecting an X-ray signal, created by the electron beam, from at least one position of the first and/or second metal powder layer and/or a melt pool of the first and/or second metal powder layer and/or a fused first and/or second powder layer by an X-ray detector,
comparing the X-ray signal with a reference signal, and
generating an alarm if the generated X-ray signal compared to the reference signal is indicating contamination material of at least one of a greater amount than a predetermined value or a deviation in Atomic % of the powder material larger than a predetermined value.

18. A non-transitory computer readable storage medium having stored thereon the program element according to claim 17.

19. A computer program product comprising at least one non-transitory computer-readable storage medium having computer-readable program code portions embodied therein, the computer-readable program code portions comprising:
at least one executable portion configured for:
applying a first metal powder layer on a work table in accordance with a model of the three dimensional article,
directing an electron beam over the work table causing the first metal powder layer to fuse in selected locations according to the model to form a first cross section of the three-dimensional article,
applying a second metal powder layer on the work table, and
directing the electron beam over the work table causing the second metal powder layer to fuse in selected locations according to the model to form a second cross section of the three-dimensional article, wherein the second layer is bonded to the first layer, and
at least one executable portion configured for:
collecting an X-ray signal, created by the electron beam, from at least one position of the first and/or second metal powder layer and/or a melt pool of the first and/or second metal powder layer and/or a fused first and/or second powder layer by an X-ray detector,
comparing the X-ray signal with a reference signal, and
generating an alarm if the generated X-ray signal compared to the reference signal is indicating contamination material of at least one of a greater amount than a predetermined value or a deviation in Atomic % of the powder material larger than a predetermined value,
wherein the steps of collecting, comparing, and generating are configured to facilitate non-destructive evaluation of a manufacturing process when forming the three-dimensional article through successive fusion of parts of a metal powder bed, which parts corresponds to successive cross sections of the three-dimensional article.

20. A computer-implemented method for non-destructive evaluation of a manufacturing process when forming a three-dimensional article through successive fusion of parts of a metal powder bed, which parts corresponds to successive cross sections of the three-dimensional article, the method comprising the steps of:
applying, via at least one computer processor, a first metal powder layer on a work table in accordance with a model of the three dimensional article,
directing, via the at least one computer processor, an electron beam over the work table causing the first metal powder layer to fuse in selected locations according to the model to form a first cross section of the three-dimensional article,
applying, via the at least one computer processor, a second metal powder layer on the work table,
directing, via the at least one computer processor, the electron beam over the work table causing the second metal powder layer to fuse in selected locations according to the model to form a second cross section of the three-dimensional article, wherein the second layer is bonded to the first layer,
collecting an X-ray signal, created by the electron beam, from at least one position of the first and/or second metal powder layer and/or a melt pool of the first and/or second metal powder layer and/or a fused first and/or second powder layer by an X-ray detector,
comparing, via the at least one computer processor, the X-ray signal with a reference signal, and
generating, via the at least one computer processor, an alarm if the generated X-ray signal compared to the reference signal is indicating contamination material of at least one of a greater amount than a predetermined value or a deviation in Atomic % of the powder material larger than a predetermined value.
